(19) United States
(12) Patent Application Publication
(10) Pub. No.: US 2011/0060719 A1
(43) Pub. Date: Mar. 10, 2011

(54) Method for Transforming Setup Data in Business Applications

(76) Inventor: Vivek Kapoor, Fremont, CA (US)

(21) Appl. No.: 12/554,889

(22) Filed: Sep. 5, 2009

(51) Int. Cl. G06F 17/30

(52) U.S. Cl. 707/602; 707/E17.044; 707/E17.005

(57) ABSTRACT

The disclosure describes a method for automating the transformation data for business applications. The method involves a transformation engine using a data map between a set of physical entities corresponding to business objects in a source database instance and a corresponding set of physical entities in a target database instance. The data transformation engine using the data map generates automatically scripts to extract data from the source database instance to a set of intermediate tables, transform the data in the set of intermediate tables, and load the transformed data to the target database instance. The data map may be generated based on one or more of foreign key information and constraint information. The method also considers the dependencies of various business objects on each other and the sequence in which the business objects should be transformed.

### BACKGROUND OF THE INVENTION

1. Field of Invention

The invention relates to the field of automating the process of data transformation across relational database instances, specifically transformation of setup data in business applications.

2. Related Art

Implementation of a business application involves multiple testing cycles on multiple instances to validate business processes. Implementation of business applications has been expensive and error-prone, partly due to lack of a well-defined, automated process for transforming setup, across multiple instances. Setup data migration for a simple module of an enterprise business application can cost, on an average, about US $30K, about 30% of the total data migration cost.

The existing methods for data transformation are as follows:
1. Enter setup data manually for every test cycle and for every new instance.
2. Develop key stroke based scripts using ETL (Extract, Transform, Load) tools.
3. Create SQL scripts to load data.

ETL tools have been used to migrate raw data between different systems, but none of the tools cater to the needs of setup data migration for business applications. Further, none of the tools provides repeatable solutions for different customers who could be implementing the same business applications.

Some enterprise business application vendors have developed their own proprietary tools to support data migration. For example, SAP has developed a tool called “SAP Accelerated Data Migration tool.” This tool is a standard ETL tool that has some built in staging tables to get data from legacy sources to the SAP database. However, such tools do not deal with the problem of “setup data” migration from an SAP ERP instance to another SAP ERP instance or from an Oracle ERP or CRM instance to another Oracle instance.

Disadvantageously, the existing methods of setup data migration across multiple relational database instances in enterprise business applications involve repetitive, manual, and/or error-prone steps.

### SUMMARY

A software tool embodying the principles of the invention automates the setup data transformation across various business test cycles and testing instances of a business application. The tool automatically generates setup data transformation scripts, based on business object metadata. The metadata may include (a) data maps between setup data for business entities in source and target instances of a relational database, and (b) the sequence in which the setup data for business objects will be transformed across instances of the relational database.

In particular embodiments, the data transformation scripts include the steps of (a) extracting setup data that needs to be migrated from a source relational database instance to an intermediate set of tables; (b) transforming the source data in the intermediate set of tables and identifying the data for columns that would change in the target instance, and (c) loading the transformed data from the intermediate set of tables to a target relational database instance.

In particular embodiments, the transformations will be for relational keys. The transformation step will transform all the necessary key IDs. Migration of setup data from one database instance to another is not simple because of ID mismatch. The primary key ID and foreign key ID may not be the same between the instances.

In some embodiments of the invention, setup data transformation scripts for vendor-supplied business application may be automatically pre-generated by basing script generation on business object metadata. Such pre-generated scripts may be reusable across multiple implementation instances.

In some embodiments of the invention, the source data and the transformed data are manually reviewed and approved by a user using a user interface, prior to loading the transformed data to the target database instance.

In some embodiments of the invention, key data columns in the source database instance, comprising at least one of a primary key column and a foreign key column, are transformed based on an ID obtained from the target database instance, while columns based on sequence are transformed based on the next sequence value obtained from the target database instance.

### DETAILED DESCRIPTION

“Setup data” is the foundational data that needs to be in place before business transactions can be created in enterprise business applications. Setup data includes master data but is different from transactional data. Master data is usually voluminous and changes more frequently than setup data. For example, in a bank transaction, the customer who wants to withdraw cash is an example of master data. However, before we can execute a bank transaction to withdraw cash, we need to first create a “bank account” for a customer. A “bank account” is an example of “setup data” and may include, for example, the structure of the account, forms of payment instruments that it can support such as cash, checks, money transfers etc.

Similarly, although customer address is considered master data, the exact format of customer address may be “setup data”. Names of countries and the cities and states in various countries are pretty standard and all may be considered “setup data”. Master data would be the real customer data, e.g., John Smith who lives in Washington D.C. has a telephone “814-990-2435”. Transactional data would be actual amount that John Smith would deposit, withdraw, transfer or pay bills from his account.

Conventionally, customers use the user interface provided in business applications to manually enter “setup data” or “configuration data.” They would then test their business transactions. They would then re-enter manually the “setup data” on a different database. They would do additional and more rigorous business transaction testing. Once satisfied, the “setup data” would be re-entered into the final production database. The conventional, manual process is expensive and error-prone.

Automation of setup data migration in an business application from a source database instance to a target database instance can not be done without solving the problem of ID mismatch. The primary key ID and foreign key ID will not be the same between database instances. A software tool embodying the principles of the invention solves the problem of ID mismatch and automates setup data migration across various business test cycles and testing instances.

In some embodiments of the invention, the software tool may include a meta data layer, an data transformation engine, and a user interface (UI) module. The meta data layer may include a data map for a relational database schema in a business application and the sequence of all setup business objects. The data map may include mapping between a set of physical entities corresponding to setup business objects in a source database instance and a corresponding set of physical entities in a target database instance. Data about the physical entities may be represented in the form of physical tables.

The data transformation engine comprises an extractor, a transformer, and a loader. The extractor will identify all the data to be transformed, based on the metadata and will extract all the data into a data file/table. The transformer will convert the extracted data file to a new data file that will have all the IDs matching to the target instance. The loader will take the transformed data from the intermediate tables and load into a target instance.

The user interface (UI) comprises an Administration UI to manage all the meta data, a run time UI, to allow users to pick and choose what setup objects need to be migrated, and an analysis UI to compare and check for any delta differences while migrating the setup data.

When migrating configuration data, it is essential to migrate data from not just one module, but data from dependent modules also. Business applications are usually implemented as a suite of related modules. For example, the “Quote to Cash” process in the Oracle ERP application includes the Oracle Quoting, Oracle Order Management, Advance Pricing, Inventory, Financials and other modules. When migrating Order Management, the setup data in all dependent modules such as Financials etc., also needs to be migrated. This invention will identify all the dependent setup data objects and the sequence in which those migrations need to happen.

The invention is not limited to ERP or CRM applications. The principles of the invention can be used for automated and error-free migration of setup data for any business application.

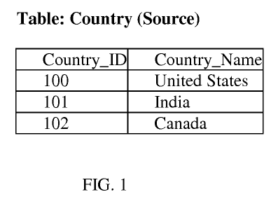

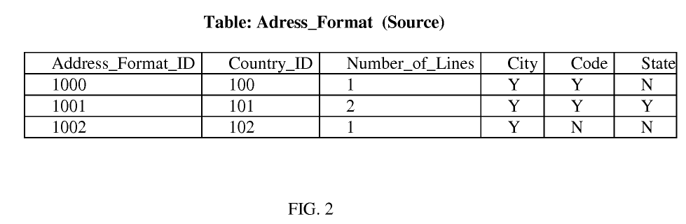

All databases use tables and tables have primary keys. Tables are related via foreign keys. An extraction step will extract the setup data from the source database instance into an intermediate transformation instance. A transformation step will transform all the necessary key IDs when setup data is migrated from a source instance (for example, a development instance) to a target instance (for example, a test instance). FIG. 1-4 illustrate the setup data transformation process and how the process can be automated. In a simple example, FIG. 1 shows setup data for “countries” in a source database instance in a tabular format. Similarly, FIG. 2 shows setup data for address format in the source database instance in a tabular format.

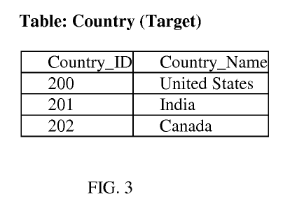

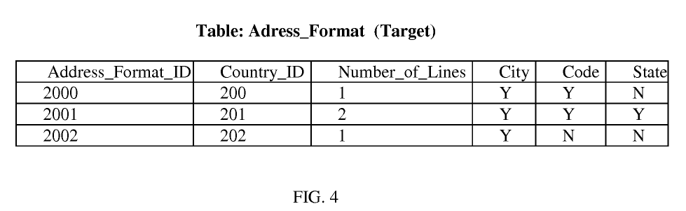

The transformation step will identify that two columns, “Country_ID” and “Address_Format_ID,” need to be transformed. Based on rules stored in metadata, the transformation engine will identify that Country_ID is the primary key in the Country table. FIG. 3 shows the Country_ID generated in the target instance. Similarly, for the Address_Format table, the transformation step will identify that the Address_Format_ID is the primary key. FIG. 4 shows the Address_Format_ID generated in the target instance. However, the Country_ID column in the Address_Format table will be identified as a foreign key referring to the Country_ID in the Country table. So the transformation rule will refer to the Country_ID column in the target instance and then accordingly transform the value.

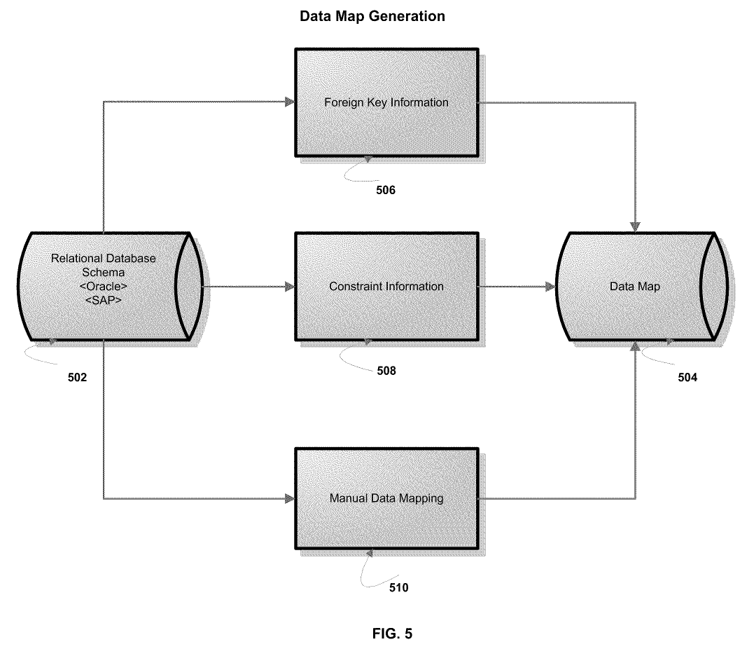

FIG. 5 shows an example of generation of a data map 504 for a relational database schema 502 (for example, Oracle, SAP, etc.) based on one or more of foreign key information 506, constraint information 508, and manual data mapping 510, etc.

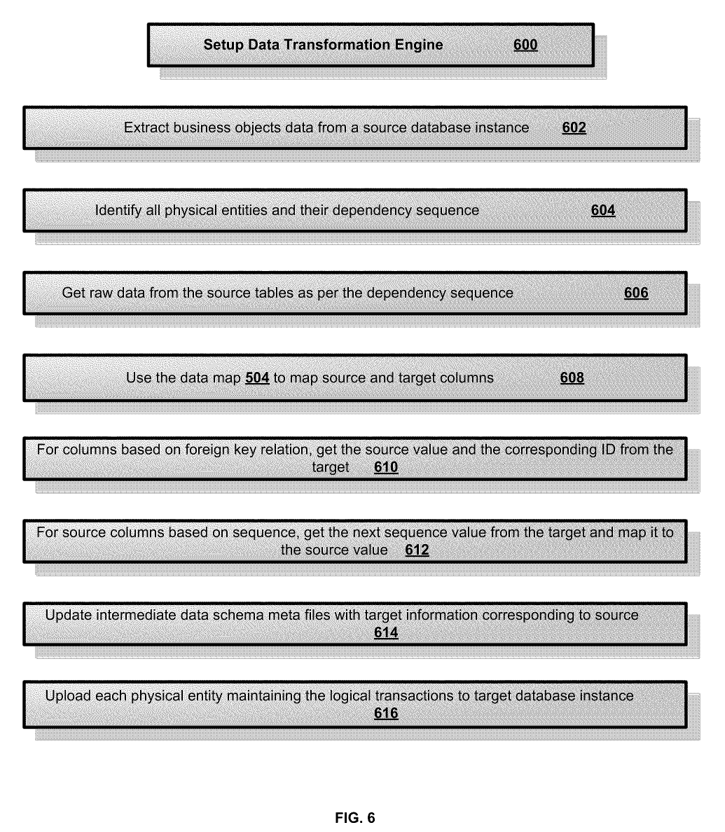

FIG. 6 shows an embodiment of a setup data transformation engine 600. In an extraction step 602, required business objects are extracted from a source database instance. In another step 604, all physical entities corresponding to the extracted business objects and their dependency sequence are identified. In another step 606, raw data is extracted from the source database instance for all physical entities, in order of their dependency sequence, from source tables in the source database instance. Data may be extracted in the form of tables or data files.

In a step 608, the data map 504 is used to map source and target columns that will need transformation.

The data stored in tables or data files is updated with target information corresponding to source information. In a step 610, for columns based on foreign key relation, the source value is obtained and the corresponding value is obtained from the target. In a step 612, for the source columns based on sequence, the next sequence value is obtained from the target and mapped to the source value.

In a step 614, intermediate data schema meta files are updated with target information corresponding to source.

In a loading step 616, the transformed data in the form of tables or data files is loaded to a target database instance. Each physical entity is uploaded while maintaining the integrity of the transactions.

In some embodiments, there may be a manual review process before the transformed data is uploaded. The transformed data may be compared column by column with the source data and manually approved before the transformed data is uploaded to the target database.

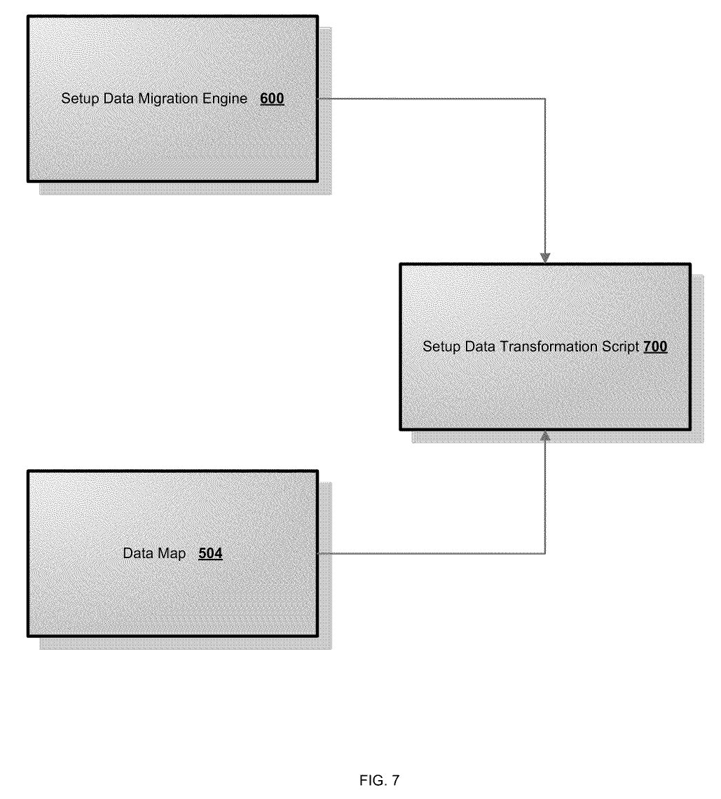

FIG. 7 shows how scripts are generated automatically by the setup data transformation engine using data maps 504. The setup data transformation engine 600 automatically generates scripts to automate the transformation process, based on stored entity data maps 504.

Although embodiments have been described with reference to a number of illustrative embodiments, it should be understood that numerous other modifications and embodiments can be devised by those skilled in the art that will fall within the spirit and scope of the disclosure. The illustrative embodiments described above are for explanatory purposes only, and not intended to limit the scope of the invention.

1. A method of automating the transformation of setup data for business applications, the method comprising:
storing metadata for a business object in a relational database schema in a business application, the metadata comprising a data map between data about the business object in a source database instance and corresponding data about the business object in a target database instance; and
generating automatically, based on the metadata, scripts to extract data from the source database instance to a set of intermediate tables, transform the data in the set of intermediate tables, and load the transformed data to the target database instance.

2. The method of claim 1, wherein the data map is generated based on one or more of foreign key information and constraint information.

3. The method of claim 1, wherein the source data and the transformed data are, optionally, manually reviewed and approved by a user using a user interface, prior to loading the transformed data to the target database instance.

4. The method of claim 1, wherein for some vendor-supplied business applications, the metadata are pre-stored; and the scripts are pre-generated and reusable.

5. The method of claim 1, wherein the metadata also comprise the dependencies of various business objects on each other and the sequence in which the business objects should be migrated from the source database instance to the target database instance.

6. The method of claim 1, wherein:
key data columns in the source database instance, comprising at least one of a primary key column and a foreign key column, are transformed based on an ID obtained from the target database instance; and
columns based on sequence are transformed based on the next sequence value obtained from the target database instance.

7. The method of claim 1, wherein the schema of the source database instance is the same as the schema of the target database instance.

8. The method of claim 1, wherein the automatically generated scripts are used for data transformation during multiple testing cycles in the implementation of business application.

9. The method of claim 1, wherein the setup business objects are limited to transaction-enabling setup objects and exclude transactional data.

10. A computer-readable medium having a computer program stored in the medium, the computer program comprising instructions for:
storing metadata for a relational database schema in a business application, the metadata comprising a data map between a set of physical entities corresponding to business objects in a source database instance and a corresponding set of physical entities in a target database instance; and
generating automatically, based on the metadata, scripts to extract data from the source database instance to a set of intermediate tables, transform the data in the set of intermediate tables, and load the transformed data to the target database instance.

11. The computer-readable medium of claim 10, wherein the data map is generated based on one or more of foreign key information and constraint information.

12. The computer-readable medium of claim 10, wherein the source data and the transformed data are, optionally, manually reviewed and approved by a user using a user interface, prior to loading the transformed data to the target database instance.

13. The computer-readable medium of claim 10, wherein for some vendor-supplied business applications, the metadata are pre-stored; and the scripts are pre-generated and reusable.

14. The computer-readable medium of claim 10, wherein the metadata also comprise the dependencies of various business objects on each other and the sequence in which the business objects should be transformed from the source database instance to the target database instance.

15. The computer-readable medium of claim 10, wherein:
key data columns in the source database instance, comprising at least one of a primary key column and a foreign key column, are transformed based on an ID obtained from the target database instance; and
columns based on sequence are transformed based on the next sequence value obtained from the target database instance.

16. The computer-readable medium of claim 10, wherein the schema of the source database instance is the same as the schema of the target database instance.

17. The computer-readable medium of claim 10, wherein the automatically generated scripts are used for data transformation during multiple cycles in the implementation of the business application.

18. The computer-readable medium of claim 10, wherein the business objects are limited to transaction-enabling setup objects and exclude transactional data.
